(19) United States
(12) Patent Application Publication
(10) Pub. No.: US 2016/0142131 A1
(43) Pub. Date: May 19, 2016

(54) OPTICAL TRANSMITTER MODULE

(71) Applicant: Fujitsu Optical Components Limited, Kawasaki-shi (JP)

(72) Inventor: Koji OTSUBO, Yokohama (JP)

(73) Assignee: Fujitsu Optical Components Limited, Kawasaki-shi (JP)

(21) Appl. No.: 14/841,831

(22) Filed: Sep. 1, 2015

(30) Foreign Application Priority Data
Nov. 18, 2014 (JP) 2014-234040

(51) Int. Cl. H04B 10/071

(52) U.S. Cl. CPC H04B 10/071

(57) ABSTRACT

An optical transmission device includes a light source, a driver, and a light receiving element. In accordance with electronic signals supplied from a signal line, the light source emits forward a signal light and emits back a monitor light for monitoring the signal light. The driver is disposed behind the light source and supplies the electronic signals to the signal line. The driver has a reflection area that reflects the monitor light in a direction different from a direction in which the monitor light, which is emitted back from the light source in accordance with the electronic signal, travels. The light receiving element receives the monitor light that is reflected on the reflection area of the driver.

### CROSS-REFERENCE TO RELATED APPLICATION

This application is based upon and claims the benefit of priority of the prior Japanese Patent Application No. 2014-234040, filed on Nov. 18, 2014, the entire contents of which are incorporated herein by reference.

### FIELD

The embodiment discussed herein is related to an optical transmitter module.

### BACKGROUND

Electro-absorption modulated integrated lasers (EML), directly modulated lasers (DML), etc., are known as light sources used for optical communication systems. A DML is a light source that directly modulates an output light in accordance with electronic signals that are supplied from a driver. Because the structure of a DML is simpler than that of an EML, application of DMLs to high-speed optical communication systems, such as Ethernet (trademark) of 100 Gbps, is currently studied.

Meanwhile, an optical transmitter that mounts a light source, such as a DML, performs automatic power control (APC) to keep the level of a signal light that is emitted from the light source at a desired level. In order to perform the APC control, the signal light emitted from the light source is monitored. Thus, various methods of mounting a light receiving element that receives a monitor light for monitoring a signal light on an optical transmitter are proposed.

As a configuration in which a light receiving element is mounted, a configuration is known in which a light receiving element is disposed behind a light source that emits a signal light forward and light emitted back from the light source is received as a monitor light.

As a configuration in which light emitted back from the light source is received, there is a configuration in which a raised area that is higher than a surface on which a light source is mounted and that has a reflection area is formed on a substrate on which the light source is mounted, a light receiving element is disposed on the raised area, and light emitted back from the light source is reflected on the reflection area to cause the light to be incident on the light receiving element.

Patent Document 1: Japanese Laid-open Patent Publication No. 2003-270496

The above-described conventional technology, however, has a problem in that the length of a signal line that supplies electronic signals to the light source increases.

In other words, in a configuration in which a light receiving element is disposed behind a light source and receives light emitted back from the light source, when the light source and a driver are connected via a signal line, because the signal line is disposed such the light receiving element disposed behind the light source is avoided, the length of the signal line increases.

Furthermore, in a configuration in which a light receiving element is disposed on a raised area of a substrate and light emitted back from a light source is reflected on a reflection area on the raised area to cause the light to be incident on the light receiving element, because a signal line is disposed such that the reflection area on the raised area is avoided in addition to the light receiving element, the length of the signal line also increases. The increase in the length of the signal line causes deterioration of electronic signals, which is not preferable.

Another configuration can be considered in which a part of a signal light that is emitted forward from a light source is received as a monitor light. For example, a configuration can be considered in which a part of the signal light emitted forward from the light source is split off by a beam splitter and the split-off light is received as a monitor light by a light receiving element. In this configuration, because a driver can be disposed behind the light source and the light source and the driver can be close to each other, an increase in the length of the signal line that connects the light source and the driver can be prevented; however, because the signal light is partly used as the monitor light, a loss of the signal light occurs.

### SUMMARY

According to an aspect of an embodiment, an optical transmitter module includes a light source that, in accordance with electronic signals supplied from a signal line, emits forward a signal light and emits back a monitor light for monitoring the signal light; a driver that is disposed behind the light source, that supplies the electronic signals to the signal line, and that has a reflection area that reflects the monitor light in a direction different from a direction in which the monitor light, which is emitted back from the light source in accordance with the electronic signal, travels; and a light receiving element that receives the monitor light that is reflected on the reflection area of the driver.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting an exemplary configuration of an optical transmitter module according to an embodiment;

FIG. 2 is an explanatory diagram for explaining another exemplary configuration in which a light receiving element is disposed behind a light source to receive light that is emitted back from the light source;

FIG. 3 is an explanatory diagram for explaining still another exemplary configuration in which a light receiving element is disposed behind a light source to receive light that is emitted back from the light source;

FIG. 4 is an explanatory diagram for explaining an exemplary configuration in which a part of a signal light emitted forward from a light source is received as a monitor light; and

FIG. 5 is an explanatory diagram for explaining a method of manufacturing a driver according to the embodiment.

### DESCRIPTION OF EMBODIMENT

Preferred embodiments of the present invention will be explained with reference to accompanying drawings. The embodiment does not limit the disclosed technology.

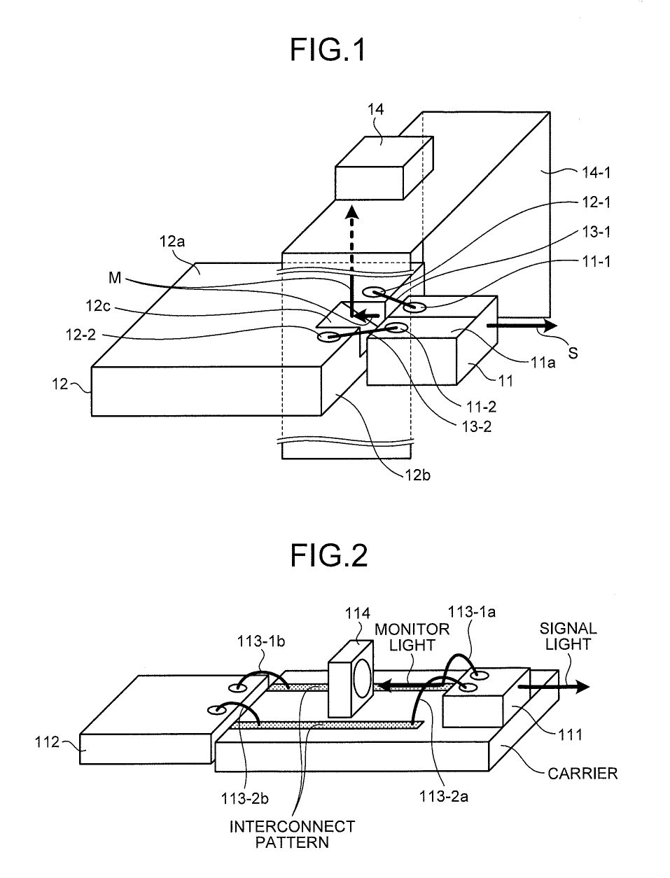

FIG. 1 is a diagram depicting an exemplary configuration of an optical transmitter module according to an embodiment. As depicted in FIG. 1, the optical transmitter module according to the embodiment includes a light source 11, a driver 12, signal lines 13-1 and 13-2 that electrically connect the light source 11 and the driver 12, and a light receiving element 14. In the following descriptions, it is assumed that the rightward direction in FIG. 1 is the forward direction with respect to the light source 11 and the leftward direction in FIG. 1 is the backward direction with respect to the light source 11.

In accordance with electronic signals supplied from the signal lines 13-1 and 13-2, the light source 11 emits forward a signal light S and emits back a monitor light M for monitoring the signal light S. The light source 11 is, for example, a directly modulated laser (DML). On an upper surface 11a of the light source 11, electrodes 11-1 and 11-2 that receive inputs of electronic signals from the signal lines 13-1 and 13-2 are formed.

The driver 12 is a diver that is disposed behind the light source 11 and that supplies electronic signals for driving the light source 11 to the signal lines 13-1 and 13-2. On an upper surface 12a of the driver 12, electrodes 12-1 and 12-2 that output electronic signals to the signal lines 13-1 and 13-2 are formed.

The signal line 13-1 connects the electrode 11-1 formed on the upper surface 11a of the light source 11 and the electrode 12-1 formed on the upper surface 12a of the driver 12. The signal line 13-2 connects the electrode 11-2 formed on the upper surface 11a of the light source 11 and the electrode 12-2 formed on the upper surface 12a of the driver 12.

The light receiving element 14 is supported by a support member 14-1 above the light source 11 and the driver 12.

As depicted in FIG. 1, the driver 12 has a reflection area 12c on a side surface 12b intersecting the direction in which the monitor light M emitted back from the light source 11 in accordance with the electronic signal travels. The reflection area 12c reflects the monitor light M in a direction different from the direction in which the monitor light M, which is emitted back from the light source 11, travels. According to the example depicted in FIG. 1, the reflection area 12c reflects the monitor light M in the direction intersecting the direction in which the monitor light M travels, i.e., toward the light receiving element 14 supported above the light source 11 and the driver 12. On the light receiving element 14, the monitor light M reflected on the reflection area 12c is incident.

The reflection area 12c is formed to have an oblique surface from the side surface 12b of the driver 12 to an area, from among the upper surface 12a of the driver 12, excluding the area in which the electrodes 12-1 and 12-2 are formed. According to the example depicted in FIG. 1, the reflection area 12c is formed to have an oblique surface from the side surface 12b of the driver 12 to the area, from among the upper surface 12a of the driver 12, between the electrodes 12-1 and 12-2.

The angle of obliquity of the reflection area 12c is selected such that the monitor light M reflected on the reflection area 12c is not incident on the light source 11. For example, the angle of obliquity of the reflection area 12c is set at 54°44′ with respect to the upper surface 12a of the driver 12.

As described above, in the optical transmitter module depicted in FIG. 1, the driver 12 disposed behind the light source 11 reflects the monitor light in the direction different from the direction in which the monitor light emitted back from the light source 11 travels, and the light receiving element 14 receives the reflected monitor light M. Thus, the light source 11 and the driver 12 can be close to each other and, when the light source 11 and the driver 12 are connected via the signal lines 13-1 and 13-2, the signal lines 13-1 and 13-2 have the shortest lengths.

The signal lines 13-1 and 13-2 connect the electrode formed on the upper surface 11a of the light source 11 and the electrode formed on the upper surface 12a of the driver 12; therefore, a difference in the level between the upper surface 11a of the light source 11 and the upper surface 12a of the driver 12 unnecessarily increases the lengths of the signal lines 13-1 and 13-2 connecting the electrode formed on the upper surface 11a of the light source 11 and the electrode formed on the upper surface 12a of the driver 12. In order to prevent such an increase in the length of the signal lines, according to the embodiment, the levels of the upper surface 11a of the light source 11 and the upper surface 12a of the driver 12 are equal to each other.

FIG. 2 is an explanatory diagram for explaining another exemplary configuration in which a light receiving element is disposed behind a light source to receive light that is emitted back from the light source. The optical transmitter module depicted in FIG. 2 has a configuration in which a light receiving element 114 is disposed behind a light source 111 by using a carrier that supports the light source 111 and the light receiving element 114 on the carrier receives a monitor light that is emitted back from the light source 111. In the optical transmitter module depicted in FIG. 2, when the light source 111 and a driver 112 are connected via signal lines, signal lines are disposed such that the light receiving element 114 disposed behind the light source 111 is avoided. In other words, in the example depicted in FIG. 2, signal lines 131-1a and 131-2a, an interconnect pattern on the carrier, and signal lines 131-1b and 131-2b connect the light source 111 and the driver 112. When the signal lines are disposed such that the light receiving element 114 disposed behind the light source 111 is avoided, the lengths of the signal lines increase practically.

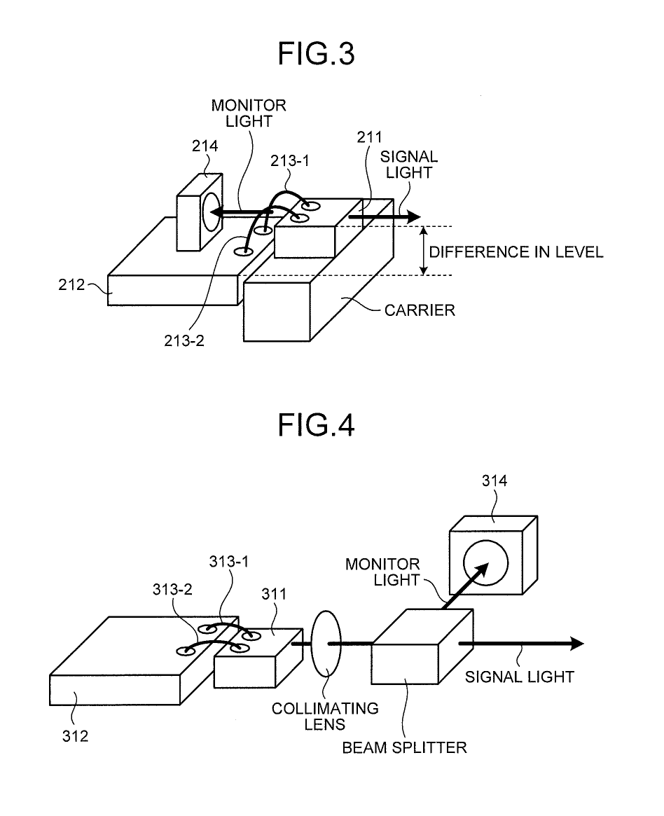

FIG. 3 is an explanatory diagram for explaining still another exemplary configuration in which a light receiving element is disposed behind a light source to receive light that is emitted back from the light source. The optical transmitter module depicted in FIG. 3 has a configuration in which a light receiving element 214 is disposed behind a light source 211 by fixing the light receiving element 214 on a driver 212 and the light receiving element 214 on the driver 212 receives a monitor light that is emitted back from the light source 211. In the optical transmitter module depicted in FIG. 3, when the light source 211 on the carrier and the driver 212 are connected via signal lines, the signal lines are disposed such that the light receiving element 214 disposed behind the light source 211 is avoided. In other words, according to the example depicted in FIG. 3, signal lines 213-1 and 213-2 that offset the difference in the level between the upper surface of the light source 211 and the upper surface of the driver 212 connect the light source 211 and the driver 212. When the signal lines are disposed such that the light receiving element 214 disposed behind the light source 211 is avoided as described above, the lengths of the signal lines increase practically.

As a configuration in which light emitted back from a light source is received, there is a configuration in which a raised area that is higher than a surface on which a light source is mounted and that has a reflection area is formed on the substrate on which the light source is mounted, a light receiving element is disposed on the raised area, and light emitted back from the light source is reflected on the reflection area to cause the light to be incident on the light receiving element. With the configuration, however, because signal lines are disposed such that the reflection area on the raised area is avoided in addition to the light receiving element, the lengths of the signal lines increase as in the configurations depicted in FIGS. 2 and 3.

In contrast to the configurations depicted in FIGS. 2 and 3, in the optical transmitter module depicted in FIG. 1, the driver 12 disposed behind the light source 11 reflects the monitor light, which is emitted back from the light source, in the direction different from the direction in which the monitor light travels and the light receiving element 14 receives the reflected monitor light M. Accordingly, the light source 11 and the driver 12 can be close to each other and, when the light source 11 and the driver 12 are connected via the signal lines 13-1 and 13-2, t the signal lines 13-1 and 13-2 have the shortest lengths. As a result, it is possible to receive the monitor light emitted from the light source 11 in accordance with electronic signals while preventing an increase in the lengths of the signal lines that supplies electronic signals to the light source 11.

FIG. 4 is an explanatory diagram for explaining an exemplary configuration in which a part of a signal light emitted forward from a light source is received as a monitor light. The optical transmitter module depicted in FIG. 4 has a configuration in which a collimating lens collimates a signal light that is emitted forward from a light source 311, a beam splitter splits a part of the collimated signal light, and a light receiving element 314 receives the split light. In the optical transmitter module depicted in FIG. 4, the light source 311 and a driver 312 disposed behind the light source 311 are connected via signal lines 313-1 and 313-2 and the light source 311 and the driver 312 are adjacent to each other. Accordingly, it is possible to prevent an increase in the lengths of the signal lines 313-1 and 313-2. In the optical transmitter module depicted in FIG. 4, because a part of the signal light is used as a monitor light, a loss of the signal light occurs.

In contrast to the configuration depicted in FIG. 4, because the optical transmitter module depicted in FIG. 1 uses the light emitted back from the light source 11, it is possible to prevent occurrence of a loss of the signal light.

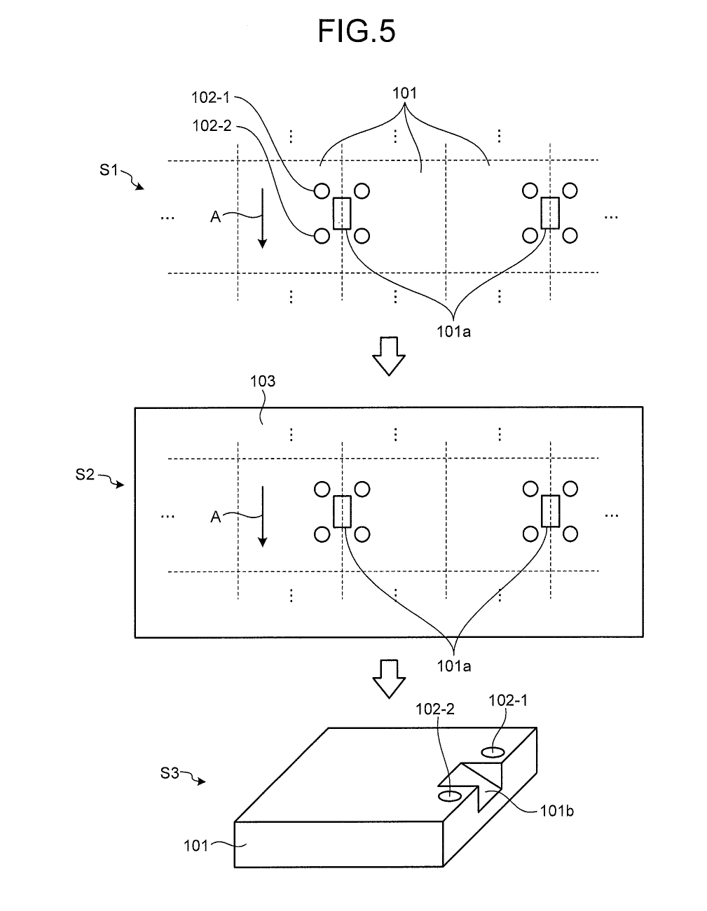

A method of manufacturing the driver 12 of the transmitter module depicted in FIG. 1 will be described below. FIG. 5 is an explanatory diagram for explaining a method of manufacturing a driver according to the embodiment.

As depicted in FIG. 5, a manufacturing apparatus forms electrode patterns 102-1 and 102-2 that is to serve as electrodes on a indium phosphide (InP) substrate 101 that is a wafer with given intervals (e.g., intervals each of which is 150 μm) (step S1). The manufacturing apparatus forms the electrode patterns 102-1 and 102-2 while aligning the direction in which the electrode patterns 102-1 and 102-2 are arranged to the crystal orientation of the InP substrate 101. According to the example depicted in FIG. 5, the arrow A denotes the crystal orientation of the InP substrate 101.

On the InP substrate 101, in addition to the electrode patterns 102-1 and 102-2, various integrated circuit patterns (not depicted) are formed. From among the surface of the InP substrate 101, given areas 101a on which the electrode patterns 102-1 and 102-2 and the integrated circuit patterns are not formed are secured as areas that is to serve as reflection areas.

The manufacturing apparatus applies a resist 103 on the InP substrate 101, the electrode patterns 102-1 and 102-2, etc., and processes the resist 103 by using a photolithographic approach to form a pattern in which the given areas 101a are exposed (step S2).

The manufacturing apparatus then performs etching on the given areas 101a by using the resist 103 as a mask, removes the resist 103, and performs dicing of cutting the InP substrate 101 into chips (step S3). In this manner, drivers are obtained in each of which a reflection area 101b having an oblique surface is formed between the electrode patterns 102-1 and 102-2.

For the embodiment, the example has been illustrated in which etching for forming the reflection area is performed before dicing is performed. Alternatively, etching may be performed after dicing is performed. For etching, dry etching, wet etching, or ion beam etching may be used. Instead of etching, the reflection area may be formed by laser processing.

As described above, in the optical transmitter module according to the embodiment, the driver 12 that is disposed behind the light source 11 reflects the monitor light, which is emitted back from the light source 11, in the direction different from the direction in which the monitor light travels and the light receiving element 14 receives the reflected monitor light M. Accordingly, the light source 11 and the driver 12 can be close to each other and, when the light source 11 and the driver 12 are connected via the signal lines 13-1 and 13-2, the signal lines 13-1 and 13-2 have the shortest lengths. As a result, it is possible to receive the monitor light emitted in the direction opposite to that of the signal light in accordance with electronic signals while preventing an increase in the lengths of the signal lines that supply electronic signals to the light source 11.

In the optical transmitter module according to the embodiment, the signal lines 13-1 and 13-2 connect the electrode formed on the upper surface 11a of the light source 11 and the electrode formed on the upper surface 12a of the driver 12 and the level of the upper surface 11a of the light source 11 and the level of the upper surface 12a of the driver 12 are equal. Accordingly, it is possible to further prevent an increase in the lengths of the signal lines.

In the optical transmitter module according to the embodiment, the reflection area 12c is formed to have an oblique surface from the side surface 12b of the driver 12 to an area, from among the upper surface 12a of the driver 12, excluding the area in which the electrodes 12-1 and 12-2 are formed. Accordingly, it is possible to assuredly reflect the monitor light emitted from the light source 1 toward the light receiving element 14 while effectively using, as the reflection area, the area other than the area in which the electrodes 12-1 and 12-2 are formed from among the upper surface 12a of the driver 12.

An embodiment of the optical transmitter module disclosed herein provides effects that, while preventing the length of a signal line that supplies an electronic signal to a light source from increasing, it is possible to receive a monitor light that is emitted in a direction opposite to that of a signal light in accordance with the electronic signal.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical transmitter module comprising:
a light source that, in accordance with electronic signals supplied from a signal line, emits forward a signal light and emits back a monitor light for monitoring the signal light;
a driver that is disposed behind the light source, that supplies the electronic signals to the signal line, and that has a reflection area that reflects the monitor light in a direction different from a direction in which the monitor light, which is emitted back from the light source in accordance with the electronic signal, travels; and
a light receiving element that receives the monitor light that is reflected on the reflection area of the driver.

2. The optical transmitter module according to claim 1, wherein
the signal line connects an electrode that is formed on an upper surface of the light source and an electrode that is formed on an upper surface of the driver, and
a level of the upper surface of the light source and a level of the upper surface of the driver are equal to each other.

3. The optical transmitter module according to claim 1, wherein
the signal line connects an electrode formed on an upper surface of the light source and an electrode formed on an upper surface of the driver, and
the reflection area is formed to have an oblique surface from a side surface of the driver that intersects the direction in which the monitor light, which is emitted back from the light source, travels to an area, from among the upper surface of the driver, excluding an area in which the electrode is formed.
